(19) United States
(12) Patent Application Publication
(10) Pub. No.: US 2024/0018423 A1
(43) Pub. Date: Jan. 18, 2024

(54) METHOD FOR SELECTIVE HYDROGENATION USING A FOAMED CATALYST

(71) Applicant: IFP Energies nouvelles, Rueil-Malmaison Cedex (FR)

(72) Inventors: Florent ALLAIN, Rueil-Malmaison Cedex (FR); Yacine HAROUN, Rueil-Malmaison Cedex (FR); Marion SERVEL, Rueil-Malmaison Cedex (FR)

(73) Assignee: IFP Energies nouvelles, Rueil-Malmaison Cedex (FR)

(21) Appl. No.: 18/033,420

(22) PCT Filed: Oct. 20, 2021
(86) PCT No.: PCT/EP2021/079077

§ 371 Date: Apr. 24, 2023

(30) Foreign Application Priority Data
Oct. 29, 2020 (FR) FR2011075

(51) Int. Cl. C10G 45/40; C10G 9/36; B01J 23/44; B01J 35/10

(52) U.S. Cl. CPC C10G 45/40; C10G 9/36; B01J 23/44; B01J 35/1028; B01J 35/1076; C10G 2300/1037; C10G 2300/70

(57) ABSTRACT

The present invention relates to a method for the selective hydrogenation of polyunsaturated compounds containing at least two carbon atoms per molecule in the presence of a catalyst comprising an active phase made from at least one group VIII metal and a support in the form of a ceramic or metal foam, the catalyst having a geometric surface area of between 1000 and 7000 m²/m³ and a pore diameter of between 0.2 and 1.5 mm.

### TECHNICAL FIELD

A subject matter of the invention is a process for the selective hydrogenation of polyunsaturated compounds in a hydrocarbon feedstock, in particular in C2-C5 steam cracking cuts and steam cracking gasolines, in the presence of a catalyst provided in the form of a metal or ceramic foam.

### STATE OF THE ART

During the last twenty years, several types of foam-form supports have been developed and manufactured with different techniques. The foam supports can be made of ceramic materials, such as, for example, of alumina or silicon carbide or zirconium. Foam supports also exist with metal materials, for example made of nickel, aluminum, nickel-chromium, nickel-chromium-aluminum, and many other types of metals.

Different modes of manufacture of foam supports exist. The best-known method, which is generally used for large-scale industrial production, is the replication technique. According to this technique, a polyurethane (PU) sponge is used as support on which the ceramic or metal materials are impregnated by bringing the PU sponge into contact with a solid-liquid suspension (slurry), followed by a heat treatment stage. The manufacturing technique is well known to a person skilled in the art, and can be found in the papers by Schwartzwalder and Somers, 1963, Lange et al., 1987, for ceramic foams, and G. Stephani et al., 2006, Quadbeck et al., 2007, for metal foams.

Ceramic and metal foams can take different geometric shapes and sizes. (Ceramic or metal) foam supports are generally characterized by the size of the pores, more specifically by the number of pores per unit of length, which is referred to as PPI (Pores Per Inch). As its abbreviation indicates, it corresponds to the number of pores intercepted by a length of 1 inch or 2.54 cm. Foams are also characterized by their pore diameter, their geometric surface area (expressed in m²/m³), and also their degree of porosity, i.e. the ratio (expressed as %) between the volume occupied by the pores within the foam and the total volume occupied by said foam.

The porosity can be calculated by the following formula:

$$ε = 1 - \frac{{P}_{f}}{{p}_{mat}}$$

with:
ε: porosity or void ratio of the foam;
ρₜ:density of the foam;
ρₘₐₜ:density of the material of the foam.

Metal or ceramic foams can be used in catalytic applications, in particular in the treatment of exhaust gases and more specifically the reduction of the NOx concentration. For example, the document US2019/001266 discloses a ceramic or metal foam comprising one or more catalysts for the reduction of NOx. The document KR2015/0111183 discloses a catalyst for reforming of gasolines comprising: a metal foam and a catalyst layer consisting of a composite of at least one metal chosen from the group consisting of palladium (Pd), rhodium (Rh) and platinum (Pt), and at least one oxide chosen from the group consisting of zirconium oxide (ZrO₂), aluminum oxide (Al₂O₃) and cerium oxide (CeO₂). The document WO2011/102567 discloses a cobalt metal foam catalyst for the Fischer-Tropsch synthesis. The metal foam used in the context of this application consists of any one of the following elements or alloys: aluminum, iron, stainless steel, iron-chromium-aluminum alloy, nickel-chromium alloy, copper-nickel alloy, aluminum-copper alloy, zinc-copper alloy and silver-copper alloy. Finally, the review paper “Selective hydrogenation of 1,3-butadiene in the presence of 1-butene under liquid phase conditions using structured catalysts”, by F. J. Mendeza et al., published in Catalysis Today, 289 (2017), 151-161, discusses the use of a catalyst support in the form of aluminum foam for the selective hydrogenation of 1,3-butadiene. This document discloses that the use of a support made of aluminum foam coated with NiPd/(CeO₂—Al₂O₃) active phase gives better results in terms of conversion and in terms of selectivity in selective hydrogenation of 1,3-butadiene than a catalyst comprising the same active phase but the support of which is provided in the form of a monolith.

In this context, one of the objectives of the present invention is to provide a process for the selective hydrogenation of polyunsaturated compounds, such as diolefins and/or acetylenics and/or alkenylaromatics, in the presence of a catalyst provided in the form of a metal or ceramic foam supporting the active phase, which makes it possible to obtain hydrogenation performance qualities in terms of activity which are at least as good, indeed even better, than those of the known processes of the state of the art.

The applicant company has discovered that a catalyst based on at least one metal from Group VIII supported on a support provided in the form of a ceramic or metal foam with a geometric structure makes it possible to obtain improved catalytic performance qualities in terms of catalytic activity when it is employed in a process for the selective hydrogenation of polyunsaturated compounds.

Subject Matters of the Invention

The present invention relates to a process for the selective hydrogenation of polyunsaturated compounds containing at least 2 carbon atoms per molecule, such as diolefins and/or acetylenics and/or alkenylaromatics, contained in a hydrocarbon feedstock having a final boiling point of less than or equal to 300° C., which process is carried out at a temperature of between 0° C. and 300° C., at a pressure of between 0.1 and 10 MPa, at a hydrogen/(polyunsaturated compounds to be hydrogenated) molar ratio of between 0.1 and 10 and at an hourly space velocity of between 0.1 and 200 h⁻¹ when the process is carried out in the liquid phase, or at a hydrogen/(polyunsaturated compounds to be hydrogenated) molar ratio of between 0.5 and 1000 and at an hourly space velocity of between 100 and 40 000 h⁻¹ when the process is carried out in the gas phase, in the presence of a catalyst comprising, preferably consisting of, an active phase based on at least one metal from Group VIII and a support provided in the form of a ceramic or metal foam, said catalyst comprising a geometric surface area of between 1000 and 7000 m²/m³ and a diameter of the pores of between 0.2 and 1.5 mm.

This is because the Applicant Company has found that recourse to such catalysts, exhibiting a support in the form of a ceramic or metal foam, said catalyst simultaneously comprising a specific geometric surface area and a specific pore diameter, makes it possible, at the same conversion, to reduce the amount of active phase necessary for the reaction for the selective hydrogenation of polyunsaturated compounds and thus makes it possible to reduce the volume of catalytic bed necessary for carrying out such a reaction, while significantly improving the selectivity of the reaction toward the desired product(s).

Preferably, said catalyst comprises a geometric surface area of between 2000 and 5000 m²/m³.

Preferably, the diameter of the pores of said catalyst is between 0.3 and 1.5 mm.

Preferably, the degree of porosity of said catalyst is between 47% and 95%.

In one embodiment according to the invention, the support is a metal foam chosen from foams made of nickel, aluminum, iron, copper, nickel-chromium, nickel-chromium-aluminum, nickel-iron-chromium-aluminum, iron-chromium-aluminum, nickel-aluminum, 316L stainless steel or 310SS stainless steel.

In one embodiment according to the invention, the support is a ceramic foam chosen from foams made of alumina (Al₂O₃), silica-alumina, silicon carbide (SiC), phosphorus-alumina, magnesia (MgO), zinc oxide, zirconium oxide (ZrO₂) or cordierite (Al₃Mg₂AlSi₅O₁₈).

Preferably, said catalyst comprises a geometric surface area of between 2000 and 4000 m²/m³.

Preferably, said catalyst comprises a diameter of the pores of between 0.5 and 1.5 mm.

In one embodiment according to the invention, the feedstock is chosen from a C2 steam cracking cut or a C2-C3 steam cracking cut, and in which process the (hydrogen)/(polyunsaturated compounds to be hydrogenated) molar ratio is between 0.5 and 1000, the temperature is between 0° C. and 300° C., the hourly space velocity is between 100 and 40 000 h^{W} and the pressure is between 0.1 and 6.0 MPa.

More preferentially, the feedstock is a C2 steam cracking cut.

### DETAILED DESCRIPTION

### Definitions

Subsequently, the groups of chemical elements are given according to the CAS classification (CRC Handbook of Chemistry and Physics, published by CRC Press, editor-in-chief D. R. Lide, 81^{st} edition, 2000-2001). For example, Group VIII according to the CAS classification corresponds to the metals of Columns 8, 9 and 10 according to the new IUPAC classification.

The textural and structural properties of the support and of the catalyst described below are determined by the characterization methods known to a person skilled in the art. The total pore volume and the pore distribution are determined in the present invention by nitrogen porosimetry as described in the work “Adsorption by Powders and Porous Solids. Principles, Methodology and Applications”, written by F. Rouquérol, J. Rouquérol and K. Sing, Academic Press, 1999.

The term “specific surface area” is understood to mean the BET specific surface area (S_{BET} in m²/g) determined by nitrogen adsorption in accordance with the standard ASTM D 3663-78 established from the Brunauer-Emmett-Teller method described in the journal “The Journal of the American Chemical Society”, 1938, 60, 309.

The content of metal from Group VIII is measured by X-ray fluorescence.

Description of the Process

The present invention relates to a process for the selective hydrogenation of polyunsaturated compounds containing at least 2 carbon atoms per molecule, such as diolefins and/or acetylenics and/or alkenylaromatics, contained in a hydrocarbon feedstock having a final boiling point of less than or equal to 300° C., which process is carried out at a temperature of between 0° C. and 300° C., at a pressure of between 0.1 and 10 MPa, at a hydrogen/(polyunsaturated compounds to be hydrogenated) molar ratio of between 0.1 and 10 and at an hourly space velocity (HSV) of between 0.1 and 200 h⁻¹ when the process is carried out in the liquid phase, or at a hydrogen/(polyunsaturated compounds to be hydrogenated) molar ratio of between 0.5 and 1000 and at an hourly space velocity of between 100 and 40 000 h⁻¹ when the process is carried out in the gas phase, in the presence of a catalyst comprising, preferably consisting of, an active phase based on at least one metal from Group VIII and a support provided in the form of a ceramic or metal foam, said catalyst comprising a geometric surface area of between 1000 and 7000 m²/m³ and a diameter of the pores of between 0.2 and 1.5 mm.

Monounsaturated organic compounds, such as, for example, ethylene and propylene, are at the root of the manufacture of polymers, of plastics and of other chemicals having added value. These compounds are obtained from natural gas, from naphtha or from gas oil which have been treated by steam cracking or catalytic cracking processes. These processes are carried out at high temperature and produce, in addition to the desired monounsaturated compounds, polyunsaturated organic compounds, such as acetylene, propadiene and methylacetylene (or propyne), 1,2-butadiene and 1,3-butadiene, vinylacetylene and ethylacetylene, and other polyunsaturated compounds, the boiling point of which corresponds to the C5+ cut (hydrocarbon compounds having at least 5 carbon atoms), in particular diolefinic or styrene or indene compounds. These polyunsaturated compounds are highly reactive and result in side reactions in the polymerization units. It is thus necessary to remove them before making economic use of these cuts.

Selective hydrogenation is the main treatment developed to specifically remove undesirable polyunsaturated compounds from these hydrocarbon feedstocks. It makes possible the conversion of polyunsaturated compounds to the corresponding alkenes or aromatics while avoiding their complete saturation and thus the formation of the corresponding alkanes or naphthenes. In the case of steam cracking gasolines used as feedstock, the selective hydrogenation also makes it possible to selectively hydrogenate the alkenylaromatics to give aromatics while avoiding the hydrogenation of the aromatic rings.

The hydrocarbon feedstock treated in the selective hydrogenation process has a final boiling point of less than or equal to 300° C. and contains at least 2 carbon atoms per molecule and comprises at least one polyunsaturated compound. The term “polyunsaturated compounds” is understood to mean compounds comprising at least one acetylenic function and/or at least one diene function and/or at least one alkenylaromatic function.

More particularly, the feedstock is selected from the group consisting of a C2 steam cracking cut, a C2-C3 steam cracking cut, a C3 steam cracking cut, a C4 steam cracking cut, a C5 steam cracking cut and a steam cracking gasoline, also known as pyrolysis gasoline or C5+ cut.

The C2 steam cracking cut, advantageously used for the implementation of the selective hydrogenation process according to the invention, exhibits, for example, the following composition: between 40% and 95% by weight of ethylene and of the order of 0.1% to 5% by weight of acetylene, the remainder being essentially ethane and methane. In some C2 steam cracking cuts, between 0.1% and 1% by weight of C3 compounds can also be present.

The C3 steam cracking cut, advantageously used for the implementation of the selective hydrogenation process according to the invention, exhibits, for example, the following mean composition: of the order of 90% by weight of propylene and of the order of 1% to 8% by weight of propadiene and of methylacetylene, the remainder being essentially propane. In some C3 cuts, between 0.1% and 2% by weight of C2 compounds and of C4 compounds can also be present.

A C2-C3 cut can also advantageously be used for the implementation of the selective hydrogenation process according to the invention. It exhibits, for example, the following composition: of the order of 0.1% to 5% by weight of acetylene, of the order of 0.1% to 3% by weight of propadiene and of methylacetylene, of the order of 30% by weight of ethylene and of the order of 5% by weight of propylene, the remainder being essentially methane, ethane and propane. This feedstock can also contain between 0.1% and 2% by weight of C4 compounds.

The C4 steam cracking cut, advantageously used for the implementation of the selective hydrogenation process according to the invention, exhibits, for example, the following mean composition by weight: 1% by weight of butane, 46.5% by weight of butene, 51% by weight of butadiene, 1.3% by weight of vinylacetylene and 0.2% by weight of butyne. In some C4 cuts, between 0.1% and 2% by weight of C3 compounds and of C5 compounds can also be present.

The C5 steam cracking cut, advantageously used for the implementation of the selective hydrogenation process according to the invention, exhibits, for example, the following composition: 21% by weight of pentanes, 45% by weight of pentenes and 34% by weight of pentadienes.

The steam cracking gasoline or pyrolysis gasoline, advantageously used for the implementation of the selective hydrogenation process according to the invention, corresponds to a hydrocarbon cut, the boiling point of which is generally between 0° C. and 300° C., preferably between 10° C. and 250° C. The polyunsaturated hydrocarbons to be hydrogenated present in said steam cracking gasoline are in particular diolefin compounds (butadiene, isoprene, cyclopentadiene, and the like), styrene compounds (styrene, α-methylstyrene, and the like) and indene compounds (indene, and the like). The steam cracking gasoline generally comprises the C5-C12 cut with traces of C3, C4, C13, C14 and C15 (for example between 0.1% and 3% by weight for each of these cuts). For example, a feedstock formed of pyrolysis gasoline generally has a composition as follows: 5% to 30% by weight of saturated compounds (paraffins and naphthenes), 40% to 80% by weight of aromatic compounds, 5% to 20% by weight of mono-olefins, 5% to 40% by weight of diolefins and 1% to 20% by weight of alkenylaromatic compounds, the combined compounds forming 100%. It also contains from 0 to 1000 ppm by weight of sulfur, preferably from 0 to 500 ppm by weight of sulfur.

Preferably, the polyunsaturated hydrocarbon feedstock treated in accordance with the selective hydrogenation process according to the invention is a C2 steam cracking cut or a C2-C3 steam cracking cut or a steam cracking gasoline.

The selective hydrogenation process according to the invention is targeted at removing said polyunsaturated hydrocarbons present in said feedstock to be hydrogenated without hydrogenating the monounsaturated hydrocarbons. For example, when said feedstock is a C2 cut, the selective hydrogenation process is targeted at selectively hydrogenating acetylene.

When said feedstock is a C3 cut, the selective hydrogenation process is targeted at selectively hydrogenating propadiene and methylacetylene. In the case of a C4 cut, the aim is to remove butadiene, vinylacetylene (VAC) and butyne; in the case of a C5 cut, the aim is to remove the pentadienes. When said feedstock is a steam cracking gasoline, the selective hydrogenation process is targeted at selectively hydrogenating said polyunsaturated hydrocarbons present in said feedstock to be treated so that the diolefin compounds are partially hydrogenated to give mono-olefins and so that the styrene and indene compounds are partially hydrogenated to give corresponding aromatic compounds while avoiding the hydrogenation of the aromatic rings.

The technological implementation of the selective hydrogenation process is, for example, carried out by injection, as upflow or downflow, of the polyunsaturated hydrocarbon feedstock and of the hydrogen into at least one fixed bed reactor. Said reactor can be of isothermal type or of adiabatic type. An adiabatic reactor is preferred. The polyunsaturated hydrocarbon feedstock can advantageously be diluted by one or more reinjection(s) of the effluent, resulting from said reactor where the selective hydrogenation reaction takes place, at various points of the reactor, located between the inlet and the outlet of the reactor, in order to limit the temperature gradient in the reactor. The technological implementation of the selective hydrogenation process according to the invention can also advantageously be carried out by the implantation of at least said supported catalyst in a reactive distillation column or in reactors-exchangers or in a slurry-type reactor. The stream of hydrogen can be introduced at the same time as the feedstock to be hydrogenated and/or at one or more different points of the reactor.

The selective hydrogenation of the C2, C2-C3, C3, C4, C5 and C5+ steam cracking cuts can be carried out in the gas phase or in the liquid phase, preferably in the liquid phase for the C3, C4, C5 and C5+ cuts and in the gas phase for the C2 and C2-C3 cuts. A liquid-phase reaction makes it possible to lower the energy cost and to increase the cycle period of the catalyst.

Generally, the selective hydrogenation of a hydrocarbon feedstock containing polyunsaturated compounds containing at least 2 carbon atoms per molecule and having a final boiling point of less than or equal to 300° C. is carried out at a temperature of between 0° C. and 300° C., at a pressure of between 0.1 and 10 MPa, at a hydrogen/(polyunsaturated compounds to be hydrogenated) molar ratio of between 0.1 and 10 and at an hourly space velocity HSV (defined as the ratio of the flow rate by volume of feedstock to the volume of the catalyst) of between 0.1 and 200 h⁻¹ for a process carried out in the liquid phase, or at a hydrogen/(polyunsaturated compounds to be hydrogenated) molar ratio of between 0.5 and 1000 and at an hourly space velocity HSV of between 100 and 40 000 h⁻¹ for a process carried out in the gas phase.

In one embodiment according to the invention, when a selective hydrogenation process is carried out in which the feedstock is a steam cracking gasoline comprising polyunsaturated compounds, the (hydrogen)/(polyunsaturated compounds to be hydrogenated) molar ratio is generally between 0.5 and 10, preferably between 0.7 and 5.0 and more preferably still between 1.0 and 2.0, the temperature is between 0° C. and 200° C., preferably between 20° C. and 200° C. and more preferably still between 30° C. and 180° C., the hourly space velocity (HSV) is generally between 0.5 and 100 h⁻¹, preferably between 1 and 50 h⁻¹, and the pressure is generally between 0.3 and 8.0 MPa, preferably between 1.0 and 7.0 MPa and more preferably still between 1.5 and 4.0 MPa.

More preferentially, a selective hydrogenation process is carried out in which the feedstock is a steam cracking gasoline comprising polyunsaturated compounds, the hydrogen/(polyunsaturated compounds to be hydrogenated) molar ratio is between 0.7 and 5.0, the temperature is between 20° C. and 200° C., the hourly space velocity (HSV) is generally between 1 and 50 h⁻¹ and the pressure is between 1.0 and 7.0 MPa.

More preferentially still, a selective hydrogenation process is carried out in which the feedstock is a steam cracking gasoline comprising polyunsaturated compounds, the hydrogen/(polyunsaturated compounds to be hydrogenated) molar ratio is between 1.0 and 2.0, the temperature is between 30° C. and 180° C., the hourly space velocity (HSV) is generally between 1 and 50 h⁻¹ and the pressure is between 1.5 and 4.0 MPa.

The hydrogen flow rate is adjusted in order to have available a sufficient amount thereof to theoretically hydrogenate all of the polyunsaturated compounds and to maintain an excess of hydrogen at the reactor outlet.

In another embodiment according to the invention, when a selective hydrogenation process is carried out in which the feedstock is a C2 steam cracking cut and/or a C2-C3 steam cracking cut comprising polyunsaturated compounds, the (hydrogen)/(polyunsaturated compounds to be hydrogenated) molar ratio is generally between 0.5 and 1000, preferably between 0.7 and 800, the temperature is between 0° C. and 300° C., preferably between 15° C. and 280° C., the hourly space velocity (HSV) is generally between 100 and 40 000 h⁻¹, preferably between 500 and 30 000 h⁻¹, and the pressure is generally between 0.1 and 6.0 MPa, preferably between 0.2 and 5.0 MPa.

### DESCRIPTION OF THE CATALYST

The catalyst used in the context of the selective hydrogenation process is provided in the form of a metal or ceramic foam, said catalyst comprising, preferably consisting of, at least one active phase comprising at least one metal from Group VIII, said catalyst being provided in the form of a ceramic or metal foam comprising at least one metal from Group VIII, said catalyst comprising a geometric surface area of between 1000 and 7000 m²/m³ and a diameter of the pores of between 0.2 and 1.5 mm.

Preferably, the geometric surface area of said catalyst is between 2000 and 5000 m²/m³, and more preferentially still between 2000 and 4000 m²/m³.

Preferably, the diameter of the pores of said catalyst is between 0.3 and 1.5 mm, and more preferentially still between 0.5 and 1.5 mm.

Preferably, the degree of porosity of said catalyst is between 47% and 95%, preferably between 50% and 80%.

When the support of the catalyst is provided in the form of a metal foam, said foam is preferably chosen from foams made of nickel, aluminum, iron, copper, nickel-chromium, nickel-chromium-aluminum, nickel-iron-chromium-aluminum, iron-chromium-aluminum, nickel-aluminum or stainless steel (316L, 310SS). Preferably, said metal foam is chosen from foams made of aluminum, nickel, nickel-chromium or nickel-chromium-aluminum. These foams can include additives, such as molybdenum, manganese or also phosphorus.

When the support of the catalyst is provided in the form of a ceramic foam, said foam is preferably chosen from foams made of alumina (Al₂O₃), silica-alumina, silicon carbide (SiC), phosphorus-alumina, magnesia (MgO), zinc oxide, zirconium oxide (ZrO₂) or cordierite (Al₃Mg₂AlSi₅O₁₈). Preferably, said ceramic foam is made of alumina (Al₂O₃), silica-alumina, phosphorus-alumina, or silicon carbide (SiC).

Said metal from Group VIII of the active phase is preferably palladium.

When the metal from Group VIII is palladium, the palladium content is generally between 0.005% and 1% by weight of said element with respect to the total weight of the catalyst, preferably between 0.01% and 0.3% by weight, and more preferentially still between 0.02% and 0.3% by weight; in an even more preferred way between 0.025% and 0.2% by weight, and even more preferentially between 0.025% and 0.1% by weight.

The catalyst can additionally comprise, as active phase, an element from Group 1b, preferably chosen from silver and copper. Preferably, the element from Group 1b is silver. The content of element from Group 1b is preferably between 0.01% and 0.3% by weight with respect to the total weight of the catalyst, more preferentially between 0.015% and 0.2% by weight.

The deposition of the active phase of the catalyst on the support provided in the form of a foam can be carried out by conventional methods well known to a person skilled in the art, and is carried out in particular by coating (washcoat). This impregnation technique is carried out by completely immersing the support in the form of a ceramic or metal foam in a solution containing the precursor salt(s) of the desired active phase(s) and then taking the impregnated foam out again subsequently for drying under air (preferably a stream of air). The operation can be repeated several times. The precursor of the catalyst is generally dried at a temperature of between 50° C. and 250° C., more preferably between 70° C. and 200° C. The duration of the drying is generally between 0.5 h and 20 hours. This preparation route makes it possible to obtain a layer of active phase on the walls of the support, the thickness of said layer generally being between 10 μm and 150 μm, preferentially between 20 μm and 100 μm and more preferentially still between 30 μm and 90 μm.

Employment of the Catalyst

In one embodiment according to the invention, the catalyst can be used in a catalytic bed in a selective hydrogenation reactor in the form of a block of elements of cubic or parallelepiped shape packed on top of one another. At the wall of the reactor, the foam catalyst blocks can have a rounded shape to fully match the shape of the reactor.

The selective hydrogenation reactor used in the context of the process according to the invention can be equipped with a plurality of tubes filled with the catalyst as described above. The tubes can have a circular, square or rectangular section. The wall of the tubes can be porous or nonporous. The maximum spacing between the tubes is between 0 and 100 mm, preferentially between 0 and 20 mm. According to this embodiment, the height of the reaction section can be composed of several tubes connected to one another.

The selective hydrogenation reactor used in the context of the process according to the invention can be of the reactor-exchanger type. The reactor-exchanger is equipped with a multitude of tubes filled with the catalyst as described above. The tubes can have a circular, square or rectangular section. A heat-transfer fluid circulates between the tubes in order to dissipate the heat generated by the exothermic selective hydrogenation reactions. The direction of flow of the heat-transfer fluid can be in the same direction as, as well as in the opposite direction to, the flow of the feedstock in the tubes. The countercurrent directions remain the preferred embodiment. The heat-transfer fluid can be a liquid or a vapor which condenses.

### EXAMPLES

To illustrate the advantages of the present invention, it is proposed to compare the results in the selective hydrogenation of acetylene using:
Catalyst A: a catalyst based on palladium on an alumina support (S_{BET}=10 m²/g) which is provided in the form of beads with a diameter of 3.8 mm, the palladium content being 800 ppm by weight of Pd element with respect to the total weight of the catalyst;
Catalyst B: a catalyst based on palladium on a support in the form of a metal foam made of nickel-chromium supplied by Recemet BV®, the geometric characteristics of which are not in accordance with the invention (cf. table 1 below);
Catalysts C and D: two catalysts based on palladium on a support which is provided in the form of a foam in accordance with the invention (cf. table 1 below). The support of the catalyst C is a ceramic foam made of silicon carbide supplied by Ultramet®; the support of the catalyst D is a metal foam made of nickel-chromium supplied by Recemet By®.

For the catalysts B, C and D, the palladium active phase was deposited by the coating technique at a desired concentration in order to obtain on the final catalyst a content of palladium element of:
Catalyst B: 0.027% by weight of palladium element with respect to the total weight of the catalyst;
Catalyst C: 0.047% by weight of palladium element with respect to the total weight of the catalyst;
Catalyst D: 0.067% by weight of palladium element with respect to the total weight of the catalyst.

All the geometric characteristics of the exemplified catalysts are collated in table 1 below.

TABLE 1

| Catalyst | A | B | C | D |
|---|---|---|---|---|
| PPI of the foam | — | 10 | 30 | 30 |
| Diameter of the pores (mm) | — | 2.3 | 1.1 | 0.7 |
| Thickness of the active | 90 | 90 | 90 | 90 |
| phase layer (μm) | | | | |
| Geometric surface area | 780 | 500 | 2000 | 2800 |
| of the catalyst (m²/m³) | | | | |
| Degree of porosity (%) | 40 | 92.2 | 69 | 62 |

The operating conditions considered are given in table 2. They are identical for the four cases studied.

TABLE 2

| | |
|---|---|
| Total throughput by weight (tonnes/hour) | 39.6 |
| HSV (s⁻¹) | 8.3 |
| T (° C.) | 65 |
| P (MPa) | 2 |
| Acetylene content in the feedstock (ppm) | 2500 |
| Ethane content in the feedstock (ppm) | 200 |
| Ethylene content in the feedstock (mol/mol) | 0.5 |
| Hydrogen content in the feedstock (mol/mol) | 0.16 |
| CO content in the feedstock (ppm) | 200 |
| Propane content in feedstock (mol/mol) | 0.3371 |
| H₂/C₂H₂ (mol/mol) | 64 |

The results are given in table 3 below.

TABLE 3

| | | Content of | | | | | | |
|---|---|---|---|---|---|---|---|---|
| | | acetylene | Selectivity | | | | | Volume |
| | | at the | for | Total | Total | Reactor | Reactor | of a |
| | | outlet | ethylene | ΔT | ΔP | length | diameter | reactor |
| Catalyst | Conversion | (ppm) | (%) | (° C.) | (MPa) | (m) | (m) | (m³) |
| A | 99.95 | 1 | 57.6 | 9.8 | 0.168 | 1.91 | 1 | 1.5 |
| B | 78.2 | 545 | 95.5 | 5.94 | 0.008 | 1.91 | 1 | 1.5 |
| C | 99.97 | <1 | 61.3 | 9.6 | 0.055 | 1.53 | 1 | 1.2 |
| D | 99.97 | <1 | 61.7 | 9.6 | 0.062 | 1.09 | 1 | 0.856 |

A conversion of greater than 99% of the acetylene is observed for the catalysts A, C and D, with an outlet content of acetylene of less than or equal to 1 ppm. This conversion is achieved with a reduction in reactor volume when the process is carried out in the presence of the catalysts C and D, in comparison with a process in the presence of the catalyst A provided in the form of beads. Specifically, the use of the catalysts C and D makes possible a reduction in reactor volume respectively of 20% by volume and of 43% by volume, with respect to the volume of the reactor used in the context of the process in the presence of the catalyst A. At the same conversion, the total volume of the reactor can be reduced. The importance of the selection of the geometric surface area and of the diameter of the pores of the catalyst is also noticed. This is because the catalyst B, not in accordance with the invention, although provided in the form of a foam, exhibits mediocre results in conversion of the feedstock. In addition, it is observed that the selectivity of the catalysts C and D is increased, with a gain of 3.7 points for the case of the catalyst C and 4.1 points for the case of the catalyst D. Finally, recourse to a catalyst exhibiting a support in the form of a ceramic or metal foam makes it possible to have a higher porosity, and thus a lower pressure drop than in the case of a conventional support in the form of beads (catalyst A).

1. A process for the selective hydrogenation of polyunsaturated compounds containing at least 2 carbon atoms per molecule contained in a hydrocarbon feedstock having a final boiling point of less than or equal to 300° C., which process is carried out at a temperature of between 0° C. and 300° C., at a pressure of between 0.1 and 10 MPa, at a hydrogen/(polyunsaturated compounds to be hydrogenated) molar ratio of between 0.1 and 10 and at an hourly space velocity of between 0.1 and 200 h⁻¹ when the process is carried out in the liquid phase, or at a hydrogen/(polyunsaturated compounds to be hydrogenated) molar ratio of between 0.5 and 1000 and at an hourly space velocity of between 100 and 40 000 h⁻¹ when the process is carried out in the gas phase, in the presence of a catalyst comprising an active phase based on at least one metal from Group VIII and a support provided in the form of a ceramic or metal foam, said catalyst comprising a geometric surface area of between 1000 and 7000 m²/m³ and a diameter of the pores of between 0.2 and 1.5 mm.

2. The process as claimed in claim 1, in which said catalyst comprises a geometric surface area of between 2000 and 5000 m²/m³.

3. The process as claimed in claim 1, in which the diameter of the pores of said catalyst is between 0.3 and 1.5 mm.

4. The process as claimed in claim 1, in which the degree of porosity of said catalyst is between 47% and 95%.

5. The process as claimed in claim 1, in which the support is a metal foam chosen from foams made of nickel, aluminum, iron, copper, nickel-chromium, nickel-chromium-aluminum, nickel-iron-chromium-aluminum, iron-chromium-aluminum, nickel-aluminum, 316L stainless steel, or 310SS stainless steel.

6. The process as claimed in claim 1, in which the support is a ceramic foam chosen from foams made of alumina (Al₂O₃), silica-alumina, silicon carbide (SiC), phosphorus-alumina, magnesia (MgO), zinc oxide, zirconium oxide (ZrO₂), or cordierite (Al₃Mg₂AlSi₅O₁₈).

7. The process as claimed in claim 1, in which said metal from Group VIII is palladium.

8. The process as claimed in claim 7, wherein the palladium content is between 0.005% and 1% by weight with respect to the total weight of the catalyst.

9. The process as claimed in claim 1, in which said catalyst comprises a geometric surface area of between 2000 and 4000 m²/m³.

10. The process as claimed in claim 1, in which said catalyst comprises a diameter of the pores of between 0.5 and 1.5 mm.

11. The process as claimed in claim 1, characterized in that the feedstock is chosen from a C2 steam cracking cut or a C2-C3 steam cracking cut, and in which process the (hydrogen)/(polyunsaturated compounds to be hydrogenated) molar ratio is between 0.5 and 1000, the temperature is between 0° C. and 300° C., the hourly space velocity is between 100 and 40 000 h⁻¹ and the pressure is between 0.1 and 6.0 MPa.

12. The process as claimed in claim 11, characterized in that the feedstock is a C2 steam cracking cut.
